(19) United States
(12) Patent Application Publication
(10) Pub. No.: US 2005/0027629 A1
(43) Pub. Date: Feb. 3, 2005

(54) Method for obtaining data relating to the sentiment on a stock exchange

(76) Inventors: Anthony Jacques Louis De Breed, JK Breda (NL); Adriaan Ligtenberg, Los Altos Hills, CA (US)

Correspondence Address: Richard L Byrne, 700 Koppers Building, 436 Seventh Avenue, Pittsburgh, PA, 15219-1818, US

(21) Appl. No.: 10/474,262

(22) PCT Filed: Apr. 8, 2002
(86) PCT No.: PCT/US02/11071

(30) Foreign Application Priority Data
Apr. 6, 2001 (NL) 1017781

(51) Int. Cl. G06F 17/60

(52) U.S. Cl. 705/36

(57) ABSTRACT

The present invention relates to a method for obtaining data relating to the sentiment of transactions on an (electronic) stock exchange, comprising the following steps of:—entering by a potential principal for stock exchange transactions electronically to one or more computers with one or more memories for storing therein one or more databases of transactions considered by this potential principal for a determined time period; and subsequently, i.e. after a predetermined closing time for entering the transactions, determining a stock exchange sentiment on the basis of the content of the databases.

Trading on the stock exchange has grown sharply in recent years and the share of private individuals herein has increased considerably and is still growing. Partly owing to the development of the internet this will increase even further, since by making use of internet information which heretofore was only accessible to professionals also becomes accessible in timely manner to private individuals. In addition, also due to internet, transaction costs have fallen considerably. It is the expectation that these transaction costs will decrease still further.

Because of these developments private individuals are forming an increasingly important part of the stock exchange and are having more and more influence on price formation. Research has shown that there is a large discrepancy between the evaluation of a fund by private individuals and professional analysts or traders. It would therefore be very interesting to gain insight into the thinking of the private investor.

The present invention provides a method for obtaining data relating to the sentiment of transactions on an (electronic) stock exchange, comprising the following steps of:
entering by a potential principal for stock exchange transactions electronically to one or more computers with one or more memories for storing therein one or more databases of transactions considered by this potential principal for a determined time period; and
subsequently, i.e. after a predetermined closing time for entering the transactions, determining a stock exchange sentiment on the basis of the content of the databases. It hereby becomes the possible to automatically record which transactions an investor on the stock exchange is considering. A great advantage hereof is that the attitude of a large number of investors in respect of determined funds is recorded on the basis of a large number of these considerations, on the basis of which stock exchange sentiments of this group can be determined. This type of sentiment data can have, optionally after operations thereon, a predictive value, for instance for prices.

A preferred embodiment of the method further comprises a step of inputting by the principal of data concerning the actually performed transactions. This embodiment has the advantage that particularly the intentions of the investor can be compared to the actual execution thereof. If there is similarity between them, the intentions can for instance be assigned a higher predictive value. If the intentions do not develop into actually performed transactions, the reasons herefor can be used to gain more insight into the relation between intentions and an execution thereof. Another important advantage of having data concerning actually performed transactions is that analyses can be performed thereon.

A further preferred embodiment of the present method comprises a step for inputting reasons for differences between intended transactions and performed transactions. It may for instance be important for a picture to be formed of the reasons for differences between the intentions of investors and the reasons that these intentions are not carried out or, on the contrary, are carried out.

A particular preferred embodiment provides that the period of time is a day. It may for instance be useful to carry out daily measurements and to store the data of these measurements daily for the purpose of the method. It is however very well possible to choose another period of time, depending on for instance the liveliness of the trading in a fund.

For the purpose of carrying out analyses, a particular embodiment of the method provides steps for:
determining a fund score in respect of a stock exchange fund by relating data concerning desired transactions in the period of time to data concerning desired transactions in a subsequent period, wherein the closing price of the day is stored in the database if it is a significant sentiment. An advantage hereof is that only data is stored relating to significant sentiments. It is for instance much more useful to obtain information about rapid value increases or value decreases than about marginal developments.

A further preferred embodiment of the present invention provides a method which further comprises a step for determining a price prediction by relating the closing price from the databank with funds in respect of desired transactions of the first period to the closing price of funds in respect of desired transactions after a second period of time, wherein there results a positive significant difference in a first price prediction and a negative significant difference in a second price prediction. An advantage hereof is that shorter term developments, such as the above described sentiments concerning the differences between two successive days, can be compared to longer term developments, such as for instance developments of the sentiment over a period of two weeks. The first price prediction can for instance be given the value one and the second price prediction can for instance be given the value zero. If a price prediction is significant, and thereby acquires the value one, this means that the sentiment is developing in positive sense in the case of a purchase sentiment, or that the sentiment is developing in negative sense in the case of a selling sentiment. If a price prediction is not significant, and thereby acquires the value zero, this means that the sentiment is changing minimally, whereby the predictive value is low.

A further embodiment of the present invention is a method, which further provides a step for determining the chance of a successful price prediction by relating a number of significant price predictions to a total number of price predictions in a determined period. This has the advantage that in respect of predictions a determination is made on the basis of real data from the past relating to how great is the reliability of predictions. On the basis of the chance of a successful price prediction in a fund an estimate can be made as to the reliability of the sentiment data of the investors. This is a powerful support means in taking decisions.

A further preferred embodiment according to the present invention provides a step for supplying one or more of said data to principals. This can take place automatically by making use of computers on the basis of data in the databanks.

A further preferred embodiment of the present invention provides that the transactions are purchase and/or sale transactions. This has the advantage that all the above stated steps can relate to both purchase and sale transactions.

A further preferred embodiment of the present method has the feature that the second period of time is a period of for instance two weeks. This makes it possible to compare sentiment differences in a short term of for instance one day to developments in a longer term such as for instance the said two weeks. It is certainly conceivable for both period lengths to be changed in order to obtain predictions which are preferred in specific situations.

A further preferred embodiment of the present method provides a system of one or more computers coupled via one or more networks to one or more other computers for performing the method.

Further advantages, features and details of the present invention will become apparent upon reading of the following description which refers to the drawings, wherein:

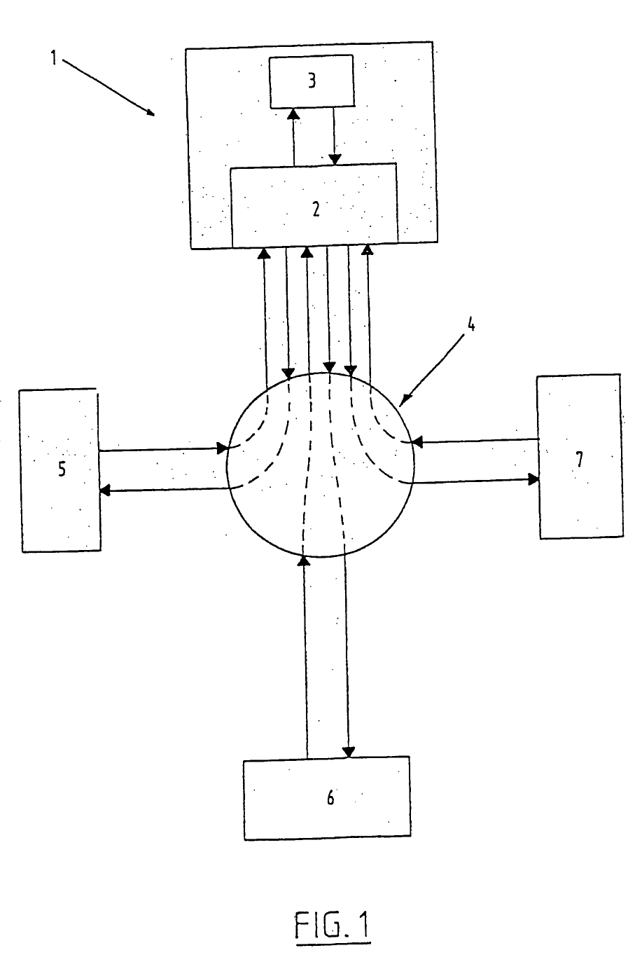

FIG. 1 shows a block diagram of an example of a computer system for performing the method of the present invention;

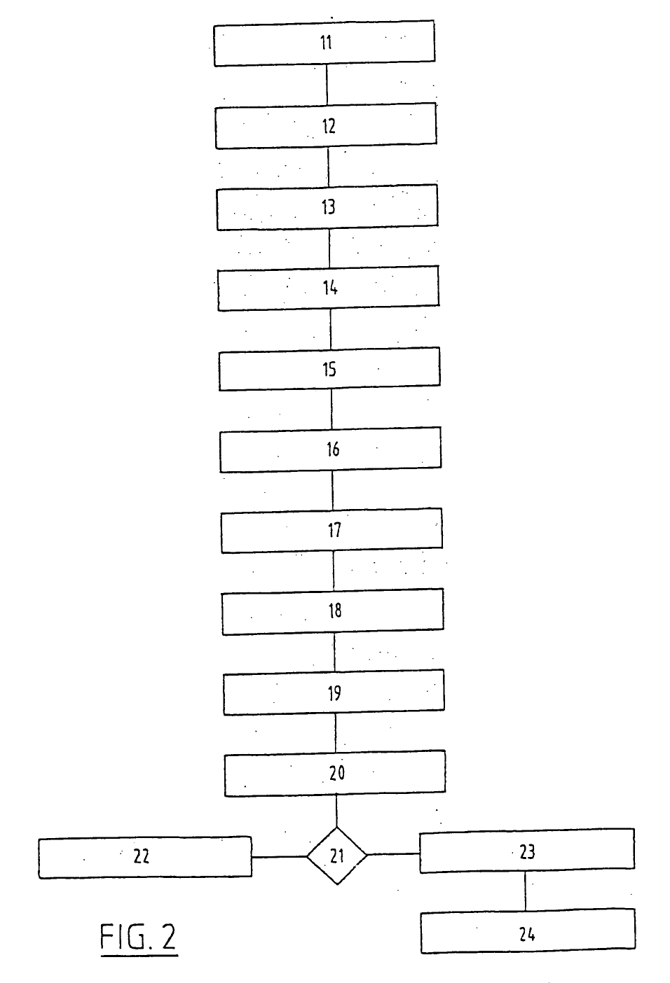

FIG. 2 is a block diagram showing a preferred embodiment of the present invention;

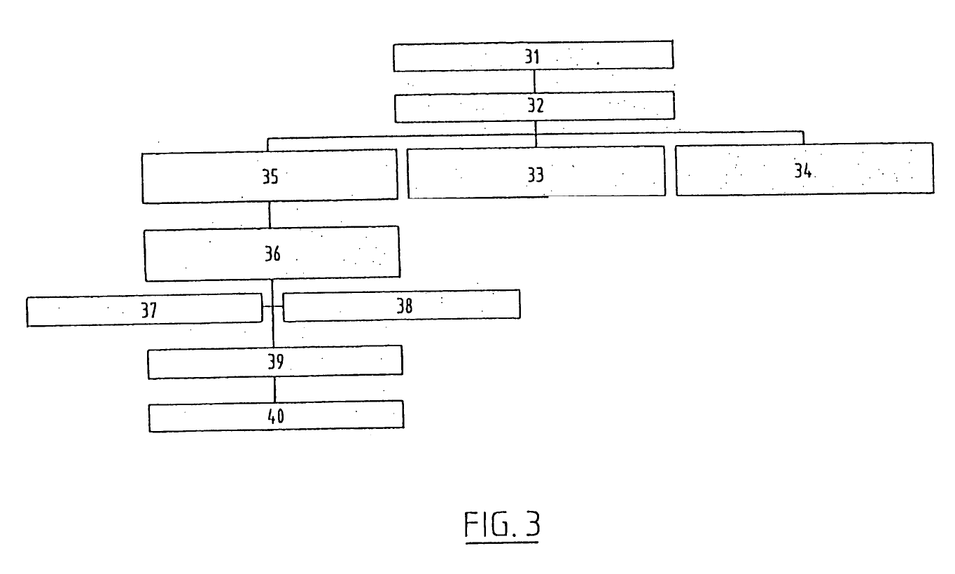

FIG. 3 is a block diagram showing another preferred embodiment;

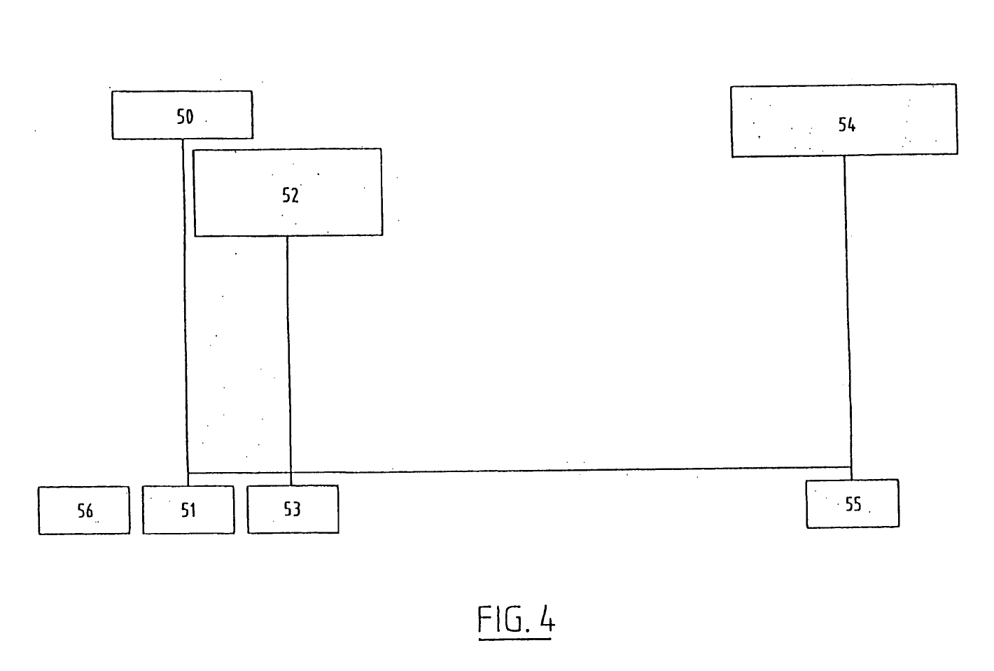

FIG. 4 is a block diagram showing another preferred embodiment;

FIG. 1 shows a computer system 1 that consists inter alia of a central processing unit 2 and a memory 3. This computer 1 is connected to the internet 4. The internet 4 is used to connect computer 1 to computers 5, 6 and 7. Computer 5 is used to input data about stock exchange transactions by potential principals. These potential principals are people who effect purchase and sale transactions on the stock exchange, in particular private investors. Computer 6 is preferably a computer of a supplier of price information. Computer 6 of the stock exchange sends price information via the internet to computer 1. Computer 7 is the computer of parties other than the stock exchange and the investors who wish to receive information generated using the method. These parties may for instance be the companies which have their shares listed on the stock exchange. It may be interesting for these companies to obtain data concerning the sentiments of the investors about their share. A reason for this may be that the investors influence the price by means of these sentiments.

An investor makes contact in FIG. 2 with the internet. He logs in on a system of the method in 11 in order to be able to begin inputting data. Another manner of inputting data is for instance via e-mail messages in 12.

The investor or respondent then enters his share portfolio in 13, since an investor preferably only inputs an intention to sell in respect of a fund that he also possesses. In 14 this data is stored in a database on computer 1. In 15 the investor indicates which funds he wishes to sell within a specific predetermined period. This data is stored in a database in 16. In 17 the investor indicates which shares he wishes to purchase and in which quantities within a specific predetermined period. In the case of purchase the investor can name all funds which are negotiable on the stock exchange and which are used in the system. The data entered in 17 is stored in a databank in 18.

The data inputted in 13, 15 and 17 is compared in 19 to data inputted during previous log-on sessions. The changes in the mutations are further compared to changes in the portfolio in 20. If it is determined in 21 that the indicated changes have been implemented in the portfolio by means of transactions, these changes in the databases are processed in 22 as having been executed. If it is found in 21 that the change has not been implemented in the portfolio, the investor is asked for the reason why. This reason is added in 24 to the database.

FIG. 3 shows how information is sent to the computers 5, 6 and 7 by computer 1. Calculations are performed in 31 per stock exchange fund. These calculations are preferably performed during off-peak periods, for instance at night, but can also be performed in real time during peak hours.

The calculations relate to the sentiments of the investors. Examples of calculations which are performed:
the percentage of the participants which possesses a fund relative to the total number of participants (number of possessors of the share divided by the total number of participants times 100%);
unweighted sale sentiment is the percentage which is considering a sale relative to the number that possesses a relevant fund (number of persons who are thinking of selling divided by the number of persons possessing the share times 100%);
unweighted purchase sentiment is the percentage which is thinking of purchasing relative to the total number of respondents (number of persons who are thinking of purchasing divided by the total number of respondents times 100%);
weighted purchase sentiment is the number of shares which the participants are considering purchasing relative to a predefined measuring point (total number of shares which are possibly bought divided by predetermined figure times 100%);
weighted sale sentiment is the total number of shares which the respondents are considering selling relative to a predefined measuring point (total number of shares which are possibly sold divided by predetermined figure times 100%);
execution is the percentage of expected mutations which are carried out (number of mutations performed divided by the number mutations performed plus the number of mutations not performed for other reasons times 100%);
a fund score for purchase, which means the number of potential purchases of today divided by the number of potential purchases of yesterday times 100%). If this is significant (for instance 105%), the closing price of the dag later) the new closing price of this fund is recorded and the so-called price prediction calculation is performed thereon. This price prediction calculation means that the price two weeks after the significant difference in the transaction score for the purchase divided by the price of the day that the fund score for the purchase differs significantly×100%. If this price amounts to 105% or more at the moment of a purchase, it is deemed a good, significant prediction and this is designated in the database as a 1. If this price is less than 105% at the moment of a purchase, this is not a good, significant prediction and is designated in the database with a “0”.

In similar manner such fund scores are calculated for potential sales. In this case the fund score is the result of the calculation of potential sales of today divided by potential sales of yesterday times 100%. If this is significant (for instance 105%), the closing price of the day must be recorded. A determined period (for instance two weeks) later, the new price of this fund is recorded and a calculation is also performed thereon. This price prediction calculation proceeds in analogous manner as above:
price of two weeks after significant difference in fund score divided by the price of the day that the fund score differs significantly times 100%. If in the case of a sale fund score the price comes to less than for instance 95%, this is designated as good and the prediction is stored in the database with a value 1. If in the case of a sale fund score price calculation the result, the prediction, is more than 95%, this is designated as not good and the value 0 is stored in the database.

A chance of a successful prediction is defined as the number of times that a fund score differs significantly relative to the preceding period (for instance 105% of the previous day) and the number of times that a price also differs significantly (for instance 105%) after the period (of for instance two weeks). This chance of a successful prediction is calculated by dividing the number of good predictions (1) by the total number of predictions (0 or 1) times 100%.

After performing the calculations per fund in 31, this data is stored in 32 in one or more of the databases with data of the time periods. After construction the databases it is possible to distribute parts thereof to one or more of the computers 5, 6, 7 or other computers not participating in this system. For instance in 34 data relating to a change in the sentiment is sent to such other computers. Data is sent to computers 7 in 33.

In 35 verification takes place as to which investors, or respondents, have logged in via computers 5. On the basis of data in the databases it is determined in 36 which investors are sent data concerning which funds. There is no automatic right to all data, this depending on the agreements made in this respect. It is determined in 37 which funds an investor has in portfolio. It is for instance determined in 38 which possible purchases the investor has inputted, whereafter on the basis thereof data of the funds which result among others from the above described calculations are linked in 39 to data of the investor. The investor can then receive this data in 40 by means of for instance an e-mail or a personalized web page.

FIG. 5 indicates a time span by means of 56, 51, 53 and 55. These blocks each represent moments. In 50, which corresponds with day X, the investors input the above described data, such as portfolio-content and considered purchases and sales. In 52, which corresponds in time with 53, being day X+1, the investor once again inputs data. Feedback is also sent in 52 by the computer 1 which relates to the data of the day X in 51 and the data relating to the day X−1 of 56. These are the results of the calculations relating to differences between the preceding two consecutive days.

Calculations are also provided which relate to differences over a longer period, such as for instance two weeks. In 54, which corresponds with day X+two weeks in 55, data is inputted by the investor. If on the basis of this data the above described price has changed significantly, the chance of a successful prediction can be determined. The results of this type of calculation will be sent a day later (not shown) to computers 5, 6, 7 or optional other computers.

Several statistical methods of analysis can be used for accessing whether e.g. a chance of successful prediction or other indicators according to the invention achieve significant better or worse results than is to be expected. It is useful to access the number of times a prediction has come true. After entering a sentiment by a person several possibilities arise:
1. a purchase sentiment has been entered and the price has risen,
2. a purchase sentiment has been entered and the price is lowered,
3. a purchase sentiment is entered and the price has been remained equal,
4. a sell sentiment is entered and the price has risen,
5. a sell sentiment has been entered and the price has lowered,
6. a sell sentiment has been entered and the price has remained equal.

In case 1 and 5 the prediction has been right and in case en 2 and 4 the prediction has been incorrect. Cases 3 en 6 in which the prices have remained equal are removed from de data. What remains is a number of correct predictions and a number of incorrect predictions. A change of a successful prediction is defined in formula 1:

$$Percentage right = \frac{number of right predictions}{total number predictions} * 100 \%$$

In principle the chance of a correct prediction is 0,5. Therefore it is to be expected that the number of correct predictions will be around 50%. By calculating this percentage per fund it can be verified whether this is the case. Prediction categories whereby this percentage deviates from the 50% point are interesting for further examination.

A first statistical test that is applied is the paired sample sign test. What is being calculated is when the percentage of correct prediction is sufficiently far from 50% that the proposition that the sample is actually better or worse than the expected 50% can be upheld. What is being tested is g: the number of rights predictions, whereby
n=the number of values,
p=the chance a prediction is correct.

The hypothesis is:

$${H}_{0} : {P}_{g} = \frac{1}{2} ( \begin{matrix}The chance of a correct \\ prediction is equal to \frac{1}{2}\end{matrix} )$$

$${H}_{1} : {P}_{g} \neq \frac{1}{2} ( \begin{matrix}The chance that a correct \\ prediction is not equal to \frac{1}{2}\end{matrix} )$$

If the null hypothesis is valid than g has a binomial distribution with n=the number of values and

$$p = \frac{1}{2} .$$

Therefore the expectation of g equals:

$$E ( \underline{g} ) = \frac{1}{2} * n$$

The standard deviation is:

$$σ ( \underline{g} ) = \sqrt{\frac{1}{2} * \frac{1}{2} * n}$$

Therefore the Z-score is:

$$Z = \frac{\underline{g} + \frac{1}{2} - E ( \underline{g} )}{σ ( \underline{g} )} = \frac{\underline{g} + \frac{1}{2} - ( \frac{1}{2} * n )}{\sqrt{\frac{1}{2} * \frac{1}{2} * n}}$$

Associated with this Z-score is a Z-value that is being calculated using the standard normal distribution P(z≧Z). If this p-value is smaller than 0,05 than the null hypothesis is being dismissed.

A further way of assessing the predictions is by looking at the achieved return. The return per prediction is being calculated as follows:

$$Return per prediction = \frac{\begin{matrix}Price after evaluation period - \\ Price at the time of entering \\ the sentiment\end{matrix}}{\begin{matrix}Price at the time of \\ entering sentiment\end{matrix}} * 100 \%$$

With these returns the average return is calculated:

$$Average return = \frac{\begin{matrix}Sum of returns per data element \\ devided by the number of data elements\end{matrix}}{Total number of data elements}$$

By evaluating either the right number of prediction or the return of the data elements right and wrong predictions can be compared to each other. The expected average return is 0%. By calculating the average return per prediction category it can be assessed whether this is the case.

The Wilcoxon signs rank test can be used for assessing whether a prediction category is significantly better or worse than the expected return of 0%. The method is as follows: Determine for each data element the absolute return and remember whether this return has a plus sign or a minus sign. Arrange the returns from low to high (without regarding the plus or minus signs). Thus the lowest absolute deviation is assigned rank number 1 and the highest absolute deviation is assigned the highest rank number n. Add all the rank numbers of the deviations that originally had a plus sign and call this sum T+. The sum of all the rank numbers that belong to deviations originally having a minus sign is T−. If the null hypothesis is valid than it is to be expected that the T+ en T− are by and large equal. If this is not the case than this is a signal that the return is significantly higher or lower than 0%.

The null hypothesis is:
H₀: μ_{R}=0 (The average return is 0%)

The alternative hypothesis is:
H₁: μ_{R}≠0 (The average return is lower or higher than 0%)

For assessing whether T+ assumes a value that is too high or too low the distribution of T+ has to be examined.

The sum of all rank numbers is:
1+2+ . . . +n=0.5n(n+1)

Therefore: T⁺+T⁻=0.5n(n+1)

If the null hypothesis with the test is valid than the chance of a positive and a negative deviation is equal to 0,5. Therefore the value that is to be expected for T+ is:

$$E ( {T}^{+} ) = \frac{1}{2} n ( n + 1 ) * \frac{1}{2} = \frac{n ( n + 1 )}{4}$$

The standard deviation of T+ is:

$$σ ( {T}^{+} ) = \sqrt{\frac{n ( n + 1 ) ( 2 n + 1 )}{24}}$$

Herewith the Z-score can be calculated:

$$Z = \frac{{T}^{+} + \frac{1}{2} - E ( {T}^{+} )}{σ ( {T}^{+} )} = \frac{{T}^{+} + \frac{1}{2} - \frac{n ( n + 1 )}{4}}{\sqrt{\frac{n ( n + 1 ) ( 2 n + 1 )}{24}}}$$

When the p-value that belongs to this Z-value is smaller than 0,05 than the null hypothesis is being rejected.

After assessing whether the properties of the prediction categories have significant better or worse results, a possible coherence between the prediction categories and the result is assessed. What needs to be assessed is whether certain combinations of characteristics occur significantly more often than others.

For processing the coherence, e.g. the Chi-square test is applied. The Chi-square test is difficult to interpret but can serve as a basis for further ways of association. In determining the Chi-square, firstly it is determined how the table would be if it were compiled entirely by chance, and no coherence would exist. Thereafter, this table is compared with the empirical table and the degree of coherence is determined. The Chi-square is calculated with the following formula:

$${χ}^{2} = {\sum }_{i = 1}^{R} {\sum }_{j = 1}^{C} \frac{{( {O}_{ij} - {E}_{ij} )}^{2}}{{E}_{ij}}$$

in which:
R=the total number of rows in the table,
C=the total number of columns in the table,
Oᵢⱼ=the observed value in row I, column j,
Eᵢⱼ=the expected value in row i, column j.
with

$${E}_{ij} = \frac{{f}_{i .} * {f}_{. j}}{N}$$

in which:
fi.=is the row total of row i,
f.j=is the column total of column j,
N=is the total number of samples.

The larger de Chi-square the bigger the coherence is between both variables.

Another statistical test thatlis applied is Cramérs V. Cramérs V is a major of association that is based on the Chi-square. However, the number of samples and the size of the tables is being taken into account. Therefore the value of Cramérs V is between 0 in absence of any coherence and 1 in case of full coherence. Therefore the coherence between several variables can be compared. Cramérs V is calculated using the formula:

$$V = \sqrt{\frac{{χ}^{2}}{N * min ( r - 1 , c - 1 )}}$$

in which:
χ²=The Chi-square
N=The total number of observations
min(r-1,c-1)=the minimum of the number of rows or columns minus 1

Other methods for determining coherence between two variables are the Goodman and Kruskal's τ. The Goodman and Kruskal's τ is a measure of an association that is based on the PRE-principle. The letters PRE stand for the concept of “Proportional Reduction of Errors”. PRE measures are a-symmetrical measures. Therefore, it is necessary to designate a dependent variable beforehand. In this case this would be the price after the evaluation period.

The formula for calculating the Goodman and Kruskal's τ is:

$$τ = \frac{{E}_{1} - {E}_{2}}{{E}_{2}}$$

in which:

$${E}_{1} = {\sum }_{i = 1}^{R} {f}_{i .} * \frac{N - {f}_{i .}}{N}$$

$${E}_{2} = {\sum }_{j = 1}^{C} {\sum }_{i = 1}^{R} {O}_{ij} * \frac{{f}_{. j} - {O}_{ij}}{{f}_{. j}}$$

in which:
R=The total number of rows in the table,
C=The total number of columns in the table,
Oij=The observed value in row i, column j,
fi.=Row total of row i,
f.j=Column total of column j,
N=The total number of observations.

The value of the Goodman and Kruskal's τ is a percentage. This percentage indicates the degree of influence of the independent variable on the dependent variable. So if the Goodman and Kruskal's τ of variable X and variable Y is 5%, this means that adding knowledge about X will diminish the number of wrong predictions by 5%.

Further methods of analysis that can be applied include all prediction categories together, such as variance analysis or discriminant analysis. Using variance analysis it is tested whether the expectation μ for a number of populations can have the same value. It can be assessed whether the categories show significant differences within a dimension. Therefore, it can be shown whether the dimension time influences the power of prediction. Discriminant analysis is a variant of regression analysis, whereby the most notable difference has to do with the character of the dependent variable Y. Using discriminant analysis a dependent variable with a nominal skill is being used. In these methods all variables are also assessed at once. An example of result that were achieved using the method are:

| | Number | Perc. | Average |
|---|---|---|---|
| Time | observations | Right | return |
| 2 wk | 233 | 0.714 | 0.058 |
| 4 wk | 61 | 0.902 | 0.143 |
| 12 wk | 97 | 0.711 | 0.117 |

In which the 233 entered sentiments where being entered by 38 different persons, the 61 entered sentiments were entered by 5 different persons, the 97 entered sentiments were entered by 13 different persons, and the total number of 391 entered sentiments where entered by 40 different persons.

The present invention is not limited to the described preferred embodiment; the rights sought are defined by the following claims.

1. A method for obtaining data relating to the sentiment of transactions on an (electronic) stock exchange, comprising the steps of:
entering by a potential principal for stock exchange transactions electronically to one or more memories for storing therein one or more databases of transactions considered by this potential principal for a determined time period; and
subsequently, i.e. after a predetermined closing time for entering the transactions, determining a stock exchange sentiment on the basis of the content of the databases.

2. The method as claimed in claim 1, further comprising a step of inputting by the principal of data concerning the actually performed transactions.

3. The method as claimed in claim 1, further comprising a step for determining differences between intended transactions and performed transactions.

4. The method as claimed in claim 1, further comprising a step for inputting reasons for differences between intended transactions and performed transactions.

5. The method as claimed in claim 1, wherein the period of time is a day.

6. The method as claimed in claim 1, comprising a step for:
determining a fund score in respect of a stock exchange fund by relating data concerning desired transactions in a period of time to data concerning desired transactions in a subsequent period, wherein the closing price of the day is stored in the database if it is a significant sentiment.

7. The method as claimed in claim 6, wherein a sentiment is significant if there is a difference in fund score of at least a predetermined percentage.

8. The method as claimed in claim 1, further comprising a step for determining a price prediction by relating the closing price from the databank in respect of desired transactions of the day to the closing price in respect of desired transactions after a second period of time, wherein there results a positive significant difference in a first price prediction and a negative significant difference in a second price prediction.

9. The method as claimed in claim 1, further comprising a step for determining the chance of a successful price prediction by relating a number of significant price predictions to the total number of price predictions.

10. The method as claimed in claim 1, further comprising a step for supplying one or more of said data to principals.

11. The method as claimed in claim 1, wherein the transactions are purchase and/or sale transactions.

12. The method as claimed in claim 8, wherein the second period of time is a period of for instance two weeks.

13. A system of one or more computers coupled via one or more networks to one or more other computers for performing the method as claimed in claim 1.

14. A system comprising one or more computers, comprising means for performing a method for obtaining data relating to the sentiment of transactions on an (electronic) stock exchange, further comprising:
input means for entering by a potential principal for stock exchange transactions electronically to one or more computers with one or more memories for storing therein one or more databases of transactions considered by the potential principal for a determined time period, and
processing means for subsequently, i.e. after a predetermined closing time for entering the transactions, determining a stock exchange sentiment on the basis of the content of the databases.

15. The system as claimed in claim 14, further comprising input means for performing a step for inputting of data by the principal concerning the actually performed transactions.

16. The system as claimed in claim 14, further comprising processing means for performing a step for determining differences between intended transactions and performed transactions.

17. The system as claimed in claim 14, further comprising input means for performing a step for inputting reasons for differences between intended transactions and performed transactions.

18. The system as claimed in claim 14, further comprising means comprising a parameter wherein the period of time is a day.

19. The system as claimed in claim 14, comprising:
processing means for determining a fund score in respect of a stock exchange fund by relating data concerning desired transactions in a period of time to data concerning desired transactions in a subsequent period, wherein the closing price of the day is stored in the database if it is a significant sentiment.

20. The system as claimed in claim 18, further comprising processing means for determining that a sentiment is significant if there is a difference in fund score of at least a predetermined percentage.

21. The system as claimed in one or more of the claim 20, further comprising processing means for performing a step for determining a price prediction by relating the closing price from the databank in respect of desired transactions of the day to the closing price in respect of desired transactions after a second period of time, wherein there results a positive significant difference in a first price prediction and a negative significant difference in a second price prediction.

22. The system as claimed in claim 14, further comprising processing means for performing a step for determining the chance of a successful price prediction by relating a number of significant price predictions to the total number of price predictions.

23. The system as claimed in claim 14, further comprising processing means for performing a step for supplying one or more of said data to principals.

24. The system as claimed in claim 14, wherein the transactions are purchase and/or sale transactions.

25. The system as claimed in claim 21, wherein the second period of time is a period of for instance two weeks.
